(19) United States
(12) Patent Application Publication
(10) Pub. No.: US 2015/0324853 A1
(43) Pub. Date: Nov. 12, 2015

(54) Release Date Notification System

(71) Applicant: Derek Damiano, Little Falls, NJ (US)

(72) Inventor: Derek Damiano, Little Falls, NJ (US)

(21) Appl. No.: 14/271,089

(22) Filed: May 6, 2014

(51) Int. Cl. G06Q 30/02; G06Q 20/08; H04L 29/08; G06Q 10/10

(52) U.S. Cl. CPC G06Q 30/0264; G06Q 10/1095; G06Q 20/08; H04L 67/26

(57) ABSTRACT

An application software for smartphones and tablets works with a cooperating website. The app will compile a calendar and notify the user of the dates of release or availability of selected events, media and/or products, based on a targeted item database compiled by the user and stored locally on the smart device as well as remotely accessible through the website. Items can be added to the database by voice commands or keyboard entries to the smart device or by password-protected website access. Each time the app is activated, it contacts the website to launch a web crawler which retrieves and/or updates the relevant release dates. Optionally, the app/website can also retrieve price information, determine the lowest price vendor, and complete purchase transactions.

### FIELD OF INVENTION

The present invention relates to the field of application software and cooperating websites/databases for smartphones and tablet computers. More particularly, the present invention relates to application software and cooperating websites/databases which implement reminder and/or actioning systems with regard to upcoming dates, transactions and/or events.

### BACKGROUND OF THE INVENTION

With the advent of smartphones and tablet computers, people increasingly rely on these devices to organize and schedule their activities. Existing software applications for smartphones and tablets can provide users with reminders of upcoming dates and events according to input supplied by the user. But sometimes the user needs to be reminded of an event or action as to which the date has not yet been set.

The need to be reminded of such inchoate dates takes on a particular urgency with respect to the release of certain new products. Modern culture attaches a significant cachet to being among the first to have seen a long-awaited movie release, TV program release, artist/music release, author/novel release, or acquired the latest rage in electronic gadgetry. Due to the excessive consumer demand for items that are currently in vogue, advance notice of the release date of such items can often be the difference between obtaining them quickly or waiting for inventories to be replenished.

One way to get advance notice of product release dates is to periodically visit relevant vendor websites and extract the dates to a calendar/reminder application. But this procedure is onerously time-consuming and likely to miss announcements made between periodic site visits.

Therefore, there is a need for an application software for smartphones and tablet computers which will receive and process user input identifying items/products for which there are anticipated, yet-to-be-announced release dates. The requisite application software should cooperate with a website-based product database, through which data specifying release dates for the user-identified items/products are automatically acquired and formatted for access by the application software in the process of notifying the user.

### SUMMARY OF THE INVENTION

The present invention comprises an application software for smartphones and tablets and a cooperating website. The app will compile a calendar and notify the user of the dates of release or availability of selected events, media and/or products, based on a targeted item database compiled by the user and stored locally on the smart device as well as remotely accessible through the website. Items can be added to the database by voice commands, text input (non-audio) to the smart device, to the smart device or by password-protected website access. Each time the app is activated, it contacts the website to launch a web crawler which retrieves and/or updates the relevant release dates. Optionally, the app/website can also retrieve price information, determine the lowest price vendor, and complete purchase transactions for said media.

Therefore, the invention comprises three components:

(1) a calendar/notification component, which compiles a calendar and notifies the user of targeted item release dates;

(2) a linked database component, which compiles data on the targeted items selected by the user; and

(3) a cooperating website component, which periodically searches the internet to retrieve release date information regarding the targeted items, and optionally also retrieves comparative price data and/or completes purchase transactions on behalf of the user.

As used in this specification and in the claims, the following definitions apply:

“data” means digital or text data or metadata;

“display” means a visual display, an audible sound, message or signal, or a combination of both visual display and audible sound/message/signal;

“release date” means the date on which an item or product becomes available for viewing or purchase;

“targeted item” means a product or media, which can be purchased and possessed, or a performance, exhibition, or sports event, for which an attendance ticket can be purchased;

“user interface” is a means of providing user input to a computer device, including verbal commands, touch screen input, and keyboard input; and

“web-crawler” means a web browser which searches the internet for specific data and/or metadata and copies such data.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a wire-frame flow chart for the Release Date Notification System according to a first embodiment using an audio input method;

FIG. 2 is a wire-frame flow chart for the Release Date Notification System according to a second embodiment using a non-audio input method; and

FIG. 3 is a schematic diagram illustrating the operation of one embodiment of the web-crawler module of the website of the Release Date Notification System.

### DETAILED DESCRIPTION OF THE PREFERRED EMBODIMENT

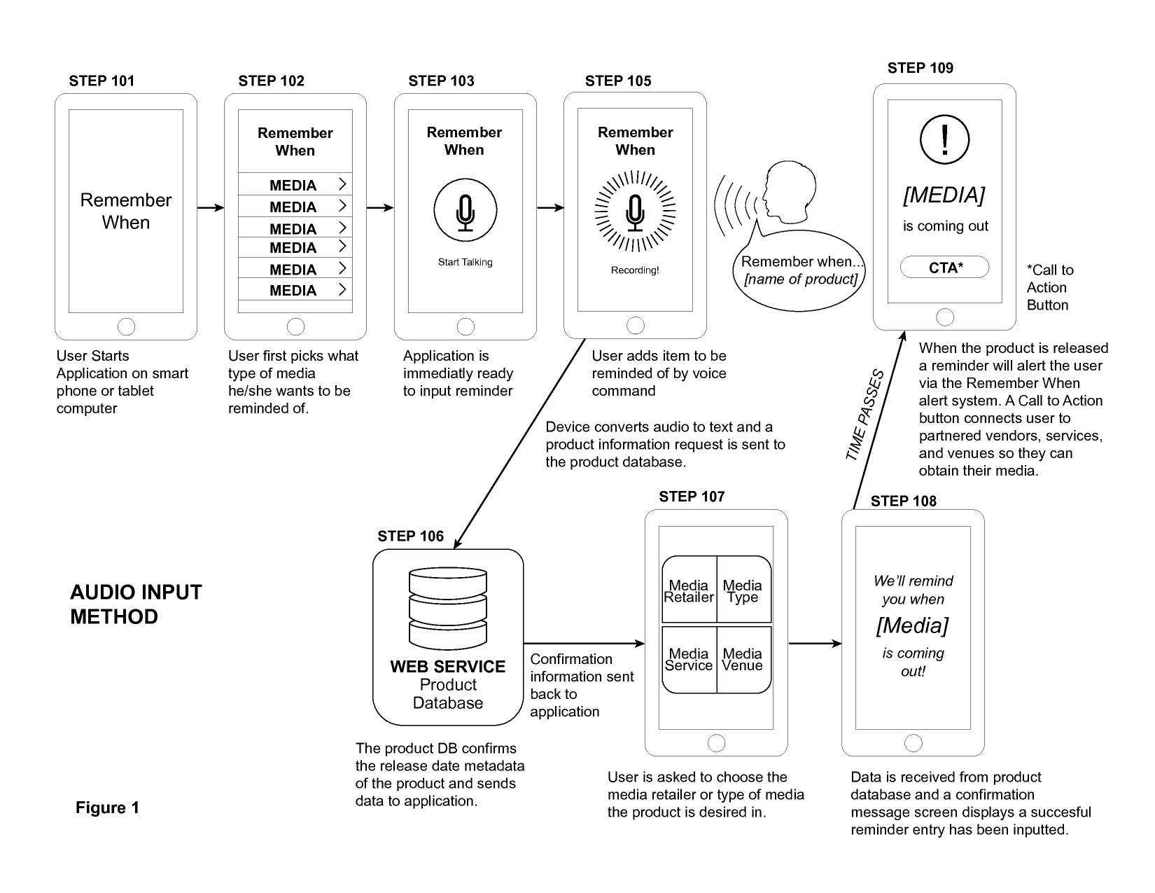

Referring to the audio-input embodiment of the present invention schematically illustrated in FIG. 1, the user opens and starts the application software on his/her smartphone or tablet 101. The user first selects a category of item for which he/she wants to be notified of the release date 102. For example, the targeted item could be a new DVD, movie, book, music, or any other product, exhibition or event that has or will have release date metadata associated with it.

Once the targeted item category is selected, the application is ready for audible user input designating the particular targeted item 103. The user then speaks a name or phrase identifying the targeted item 105. The application converts the audio data to text and sends the targeted item data to a dedicated website, where it is stored in a database module and made available to a web-crawler module 106.

The website sends a confirmation message back to the application along with an inquiry, if necessary, as to the desired format of the targeted item 107. For example, if the targeted item is a movie, available formats could include streaming video or DVD, while a targeted book could be available in ebook or print formats. Once a targeted item format has been selected, the application causes the smartphone/tablet to display the confirmation message 108.

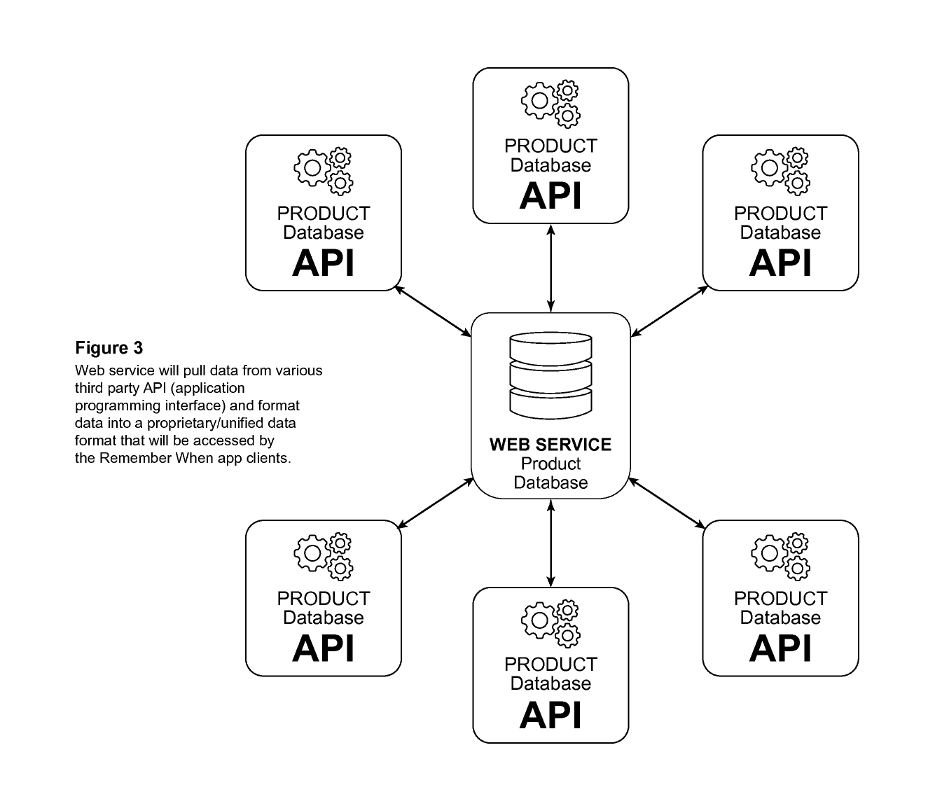

As illustrated schematically in FIG. 3, the web-crawler module of the website is activated to periodically search the internet for metadata designating the release date of the targeted item in the selected format. For example, the web-crawler can be programmed to look for metadata in which the words “release” and “date” appear in close proximity to a date format, such as MM/DD/YYYY.

When the web-crawler finds the relevant release data, it is transmitted as text to the application, which causes the smartphone/tablet to sound audibly (chime) and display it as a notification to the user 109. Optionally, the notification display 109 can include a “Call to Action” (CTA) button, through which the user can connect to one or more vendor websites to purchase the targeted item. Alternately, activation of the CTA button can cause the application to complete a purchase of the targeted item on a vendor website, based on payment information provided by the user.

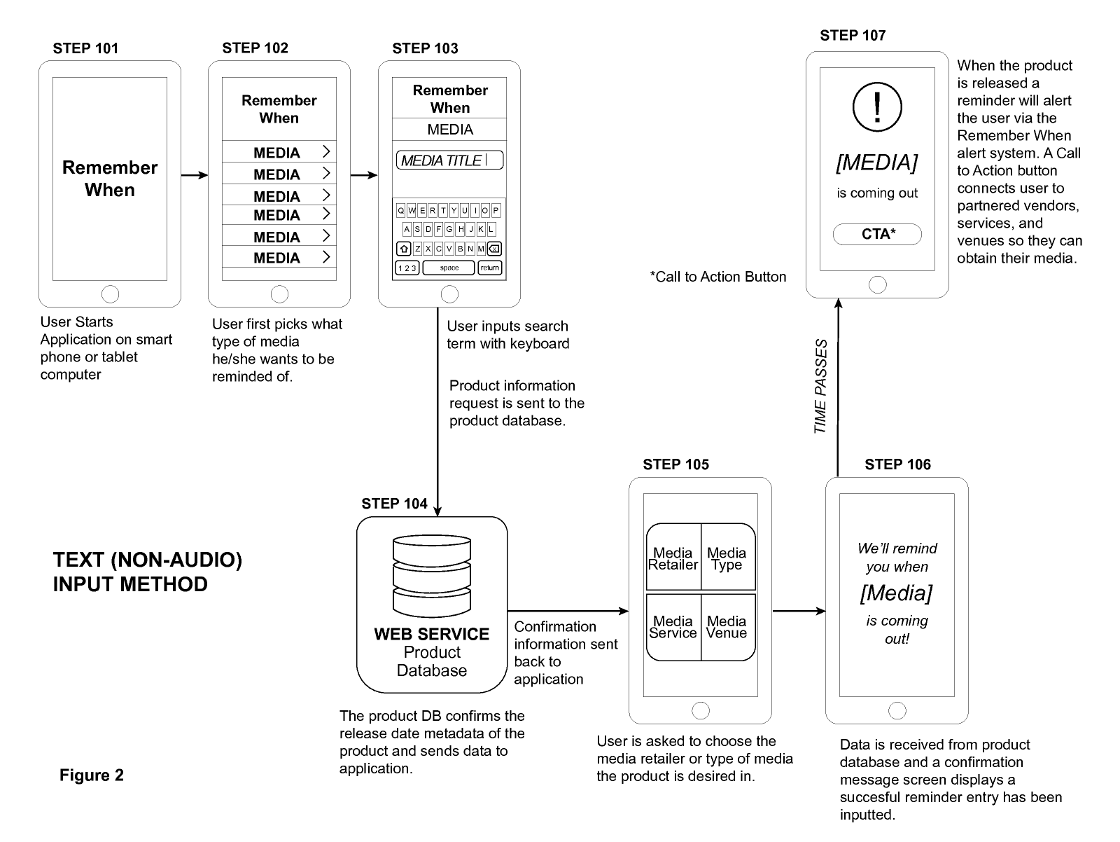

Referring to the non-audio input embodiment of the present invention schematically illustrated in FIG. 2, the user opens and starts the application software on his/her smartphone or tablet 201. The user first selects a category of item for which he/she wants to be notified of the release date 202. The user then uses a touch keyboard to spell a name or phrase identifying the targeted item 203. The application sends the text targeted item data to a dedicated website, where it is stored in a database module and made available to a web-crawler module 204.

The website sends a confirmation message back to the application along with an inquiry, if necessary, as to the desired format of the targeted item 205 or print formats. Once a targeted item format has been selected, the application causes the smartphone/tablet to display the confirmation message 206.

As illustrated schematically in FIG. 3, the web-crawler or module of the website is activated to periodically search the internet for metadata designating the release date of the targeted item in the selected format.

When the web-crawler finds the relevant release data, it is transmitted as text to the application, which cause the smartphone/tablet to sound audibly (chime) and display it as a notification to the user 207. Optionally, the notification display 207 can include a “Call to Action” (CTA) button, through which the user can connect to one or more vendor websites to purchase the targeted item. Alternately, activation of the CTA button can cause the application to complete a purchase of the targeted item on a vendor website, based on payment information provided by the user.

Although the preferred embodiments of the present invention were disclosed for illustrative purposes, those skilled in the art will appreciate that many additions, modifications and substitutions are possible, without departing from the scope and spirit of the present invention as defined by the accompanying claims.

What is claimed is:

1. A method to give a user a notification of a release date of a targeted item, the method comprising:
(a) Providing a computer device having one or more display components and one or more user interfaces;
(b) providing a website accessible by the computer device, wherein the website has a web-crawler module and a database module;
(c) providing an application software program which runs on the computer device, obtains user inputs through the user interfaces, accesses the website, and controls the display components;
(d) operating the user interfaces to provide one or more user inputs, which designate the targeted item and request the notification of the release date of the targeted item;
(e) using the application software program to convert the user inputs to targeted item data and to send the targeted item data to the website;
(f) upon reception of the targeted item data by the website, storing the targeted item data in the database module and activating the web-crawler module to periodically search the internet for release date data pertaining to the targeted item;
(g) using the web-crawler module to find and copy the release date data pertaining to the targeted item;
(h) storing the release date data in the database module so as to incorporate the release date data in the targeted item data;
(i) using the application software program to access the targeted item data and to translate the targeted item data into one or more release data notifications displayed or heard, or displayed and heard, on the display components of the computer device.

2. The method of claim 1, comprising the additional step (e*), between steps (e) and (f);
(e*) upon reception of the targeted item data by the website, sending a receipt confirmation message to the computer device, and using the application software program to cause the receipt confirmation message to be displayed or heard, or displayed and heard, on the display components of the computer device.

3. The method of claim 2, wherein the website further comprises a targeted item purchase module, for which a purchasing link is included in the release date notifications, such that, when the purchasing link is activated, the purchase module accesses one or more vendor websites wherein the targeted item can be purchased.

4. The method of claim 3, wherein the purchase module completes the purchase of the targeted item on one of the vendor websites based on payment data inputted through the user interfaces.
